(19) United States
(12) Patent Application Publication
(10) Pub. No.: US 2023/0067507 A1
(43) Pub. Date: Mar. 2, 2023

(54) SYSTEM AND METHOD FOR TOKEN PROCESSING

(71) Applicant: Visa International Service Association, San Francisco, CA (US)

(72) Inventors: Anuja Seton, San Francisco, CA (US); Steven Leitman, San Francisco, CA (US); Declan Callisto, New York, NY (US); Todd Mazurek, New York, NY (US); Neerav Berry, Menlo Park, CA (US); Lacey Bartlett, San Mateo, CA (US)

(73) Assignee: Visa International Service Association, San Francisco, CA (US)

(21) Appl. No.: 17/790,720

(22) PCT Filed: Jan. 8, 2021
(86) PCT No.: PCT/US2021/012821

§ 371 Date: Jul. 1, 2022

Related U.S. Application Data
(60) Provisional application No. 63/109,713, filed on Nov. 4, 2020.
(60) Provisional application No. 63/070,646, filed on Aug. 26, 2020.
(60) Provisional application No. 63/022,783, filed on May 11, 2020.
(60) Provisional application No. 62/959,055, filed on Jan. 9, 2020.

(51) Int. Cl. G06Q 20/38; G06Q 20/14

(52) U.S. Cl. CPC G06Q 20/3821; G06Q 20/14; G06Q 2220/00

(57) ABSTRACT

A method includes receiving a token associated with the credential or a token reference identifier associated with the token from a processor computer. The method also includes transmitting the token to a biller computer, which uses the token to process the bill, by generating an authorization request message comprising the token for an interaction involving the bill. The method also includes receiving the authorization request message comprising the token, retrieving the credential associated with the token, and transmitting a modified authorization request message including the credential to an authorizing entity computer, which authorizes the interaction.

### CROSS-REFERENCES TO RELATED APPLICATIONS

This application is a PCT application of and claims the benefit of and priority to U.S. Provisional Application No. 63/109,713, filed on Nov. 4, 2020, 63/070,646, filed on Aug. 26, 2020, 63/022,783, filed on May 11, 2020, and 62/959,055, filed on Jan. 9, 2020, which are all herein incorporated by reference in their entirety for all purposes.

### BACKGROUND

Many existing bill payment schemes use real credentials such as real credit or debit card numbers to process bill payments. A problem with existing bill payments using such real credentials is that they can be subjected to man-in-the-middle attacks.

Another problem with existing bill payment systems is that a user needs to use a number of different access credentials to access the various billers that the user uses. For example, if a user uses different billers (e.g., streaming services, utility services, software subscription services, etc.), then the user needs to use a different set of authentication credentials for each biller. Further, each biller may also require a type or format of credential, and/or different mode of credential entry (e.g., biometric, one-time password, username/password, etc.). This can be difficult for a user to manage and can also result in a number of communications between the user and the different billers.

Thus, improved systems and methods for allowing users to address bills from various resource providers is needed. Embodiments of the invention address these and other problems, individually and collectively.

### BRIEF SUMMARY

One embodiment includes a method comprising: receiving, by a processing network computer, a token or a token reference identifier associated with the token from a processor computer, transmitting, by the processing network computer, the token to a biller computer, which uses the token to process the bill, by generating an authorization request message comprising the token for an interaction involving the bill; receiving, by the processing network computer, the authorization request message comprising the token; retrieving a credential associated with the token; and transmitting a modified authorization request message including the credential to an authorizing entity computer, which authorizes the interaction.

Another embodiment includes a processing network computer comprising: a processor; and a non-transitory computer readable medium, the non-transitory computer readable medium comprising instructions, executable by a processor, to cause the processing network computer to: receive a token or a token reference identifier associated with the token from a processor computer, transmit the token to a biller computer, which uses the token to process the bill, by generating an authorization request message comprising the token for an interaction involving the bill; receive the authorization request message comprising the token; retrieve a credential associated with the token; and transmit a modified authorization request message including the credential to an authorizing entity computer, which authorizes the interaction.

Another embodiment includes a method comprising: receiving, by an authorizing entity computer and from a user computing device; a request to pay a bill from a biller computer using a credential; and transmitting, by the authorizing entity computer, an initiation message to a processor computer which stores a token associated with the credential or a token reference identifier associated with the token, wherein the processor computer transmits the token or the token reference identifier to a processing network computer, which uses the token to process the bill; and receiving, by the authorizing entity computer from the biller computer, a confirmation that the bill has been processed.

Another embodiment includes an authorizing entity computer comprising: a processor; and a computer readable medium coupled to the processor. The computer readable medium comprising instructions, executable by the processor, to cause the authorizing entity computer to: receive, from a user computing device; a request to pay a bill from a biller computer using a credential; transmit an initiation message to a processor computer which stores a token associated with the credential or a token reference identifier associated with the token, wherein the processor computer transmits the token or the token reference identifier to a processing network computer, which uses the token to process the bill; and receive, from the biller computer, a confirmation that the bill has been processed.

These and other embodiments are described in further detail below.

### BRIEF DESCRIPTION OF THE DRAWINGS

FIG. 1 shows a block diagram of a system and a process flow for processing a bill payment according to an embodiment.

FIG. 2 shows a block diagram with a system and another process flow for processing a bill payment according to another embodiment.

FIG. 3 shows a block diagram of an authorizing entity computer according to an embodiment.

FIG. 4 shows a block diagram of a token service computer according to an embodiment.

FIG. 5 shows a block diagram of a processing network computer according to an embodiment

FIGS. 6A-6D show screenshots of a graphical user interface for an application that allows a user to pay a bill account according to embodiments of the invention.

FIGS. 7A-7C show additional screenshots for an application that allows a user to pay a bill account according to embodiments of the invention.

### DETAILED DESCRIPTION

Before describing specific embodiments of the invention, some descriptions of some terms may be useful.

A “user computing device” may comprise any suitable electronic device that may be operated by a user, which may also provide remote communication capabilities to a network. A user computing device may be a mobile communication device in some embodiments. Examples of mobile communication devices include mobile phones (e.g. cellular phones), PDAs, tablet computers, net books, laptop computers, personal music players, hand-held specialized readers, etc. Further examples of mobile communication devices include wearable devices, such as smart watches, fitness bands, ankle bracelets, rings, earrings, etc., as well as automobiles with remote communication capabilities. In some embodiments, a mobile communication device can function as a payment device (e.g., a mobile communication device can store and be able to transmit payment credentials for a transaction). A user computing device can operate using a mobile phone (wireless) network, wireless data network (e.g. 3G, 4G or similar networks), Wi-Fi, Wi-Max, or any other communication medium that allows remote devices to communicate with each other.

A “payment device” or “payment instrument” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, and verification values such as CVV, dCVV, CVV2, dCVV2, and CVC3 values.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other information that may be replaced with a substitute value (i.e., token). Tokenization enhances transaction efficiency and security.

A “token service computer” can include a system that services tokens. In some embodiments, a token service computer can facilitate requesting, determining (e.g., generating) and/or issuing tokens, as well as maintaining an established mapping of tokens to primary account numbers (PANs) in a repository (e.g. token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by de-tokenizing the tokens to obtain the actual PANs. In some embodiments, a token service computer may include a tokenization computer alone, or in combination with other computers such as a transaction processing network computer. Various entities of a tokenization ecosystem may assume the roles of the token service provider. For example, payment networks and issuers or their agents may become the token service provider by implementing the token services according to embodiments of the present invention.

A “token domain” may indicate an area and/or circumstance in which a token can be used. Examples of token domains may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e. token domain restriction controls) may be established as part of token issuance by the token service provider that may allow for enforcing appropriate usage of the token in payment transactions.

For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

A “token expiry date” may refer to the expiration date/time of the token. The token expiry date may be passed among the entities of the tokenization ecosystem during transaction processing to ensure interoperability. The token expiration date may be a numeric value (e.g. a 4-digit numeric value). In some embodiments, the token expiry date can be expressed as a time duration as measured from the time of issuance.

A “token request message” may be an electronic message for requesting a token. A token request message may include information usable for identifying a payment account or digital wallet, and/or information for generating a payment token. For example, a token request message may include payment credentials, mobile device identification information (e.g. a phone number or MSISDN), a digital wallet identifier, information identifying a tokenization service provider, a merchant identifier, a cryptogram, and/or any other suitable information.

Information included in a token request message can be encrypted (e.g., with an issuer-specific key).

A “token response message” may be a message that responds to a token request. A token response message may include an indication that a token request was approved or denied. A token response message may also include a payment token, mobile device identification information (e.g. a phone number or MSISDN), a digital wallet identifier, information identifying a tokenization service provider, a merchant identifier, a cryptogram, and/or any other suitable information. Information included in a token response message can be encrypted (e.g., with an issuer-specific key).

A “token requestor identifier” may include any characters, numerals, or other identifiers associated with an entity associated with a network token system.

For example, a token requestor identifier may be associated with an entity that is registered with the network token system. In some embodiments, a unique token requestor identifier may be assigned for each domain for a token request associated with the same token requestor. For example, a token requestor identifier can identify a pairing of a token requestor (e.g., a mobile device, a mobile wallet provider, etc.)

with a token domain (e.g., e-commerce, contactless, etc.). A token requestor identifier may include any format or type of information. For example, in one embodiment, the token requestor identifier may include a numerical value such as a ten digit or an eleven digit number (e.g., 4678012345).

A “user” may include an entity such as an individual or a machine. In some embodiments, a user may be associated with one or more personal accounts and/or mobile devices. The user may also be referred to as a cardholder, account holder, or consumer in some embodiments.

A “resource provider” may be an entity that can provide a resource such as goods, services, information, and/or access. Examples of resource providers include merchants, data providers, transit agencies, governmental entities, venue and dwelling operators, etc.

A “biller” may be a resource provider that provides a bill to a user to pay. Billers may include utilities, software service providers, utility providers, telecommunication providers, Internet service providers, governmental organizations, and the like.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

An “authorization request message” may be an electronic message that requests authorization for a transaction. In some embodiments, it is sent to a transaction processor computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processor computer. The authorization response message may include, by way of example only, one or more of the following status indicators: Approval —transaction was approved; Decline —transaction was not approved; or Call Center —response pending more information, merchant must call the toll-free authorization phone number. The authorization response message may also include an authorization code, which may be a code that a credit card issuing bank returns in response to an authorization request message in an electronic message (either directly or through the transaction processor computer) to the merchant's access device (e.g. POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

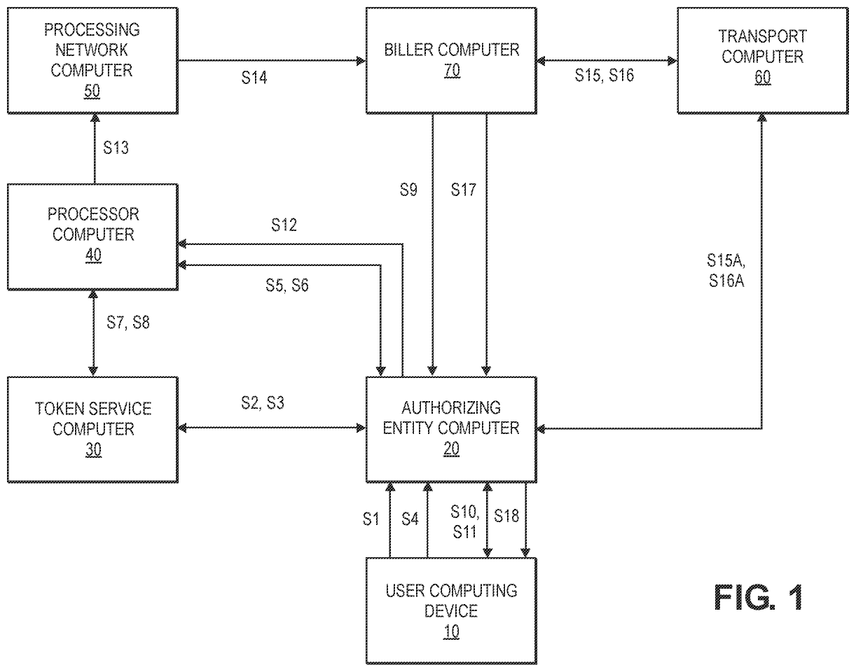

FIG. 1 shows a block diagram of a system and a process flow for processing a bill payment according to an embodiment.

FIG. 1 shows a user computing device 10 in communication with an authorizing entity computer 20. The authorizing entity computer 20 can be in communication with a token service computer 30 and a processor computer 40. The processor computer 40 may be operated by an entity such as a processing network organization, a check processing organization, a digital wallet provider, and the like.

The processor computer 40 may be in communication with a processing network computer 50. The processing network computer 50 can be communication with a biller computer 70, and a transport computer 60 operated by an entity such as an acquirer. The biller computer 70 may be operated by a biller such as a utility, a streaming service, a cable company, a cell phone service, a merchant, etc.

The processing network computer may be in a payment processing network, which may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

Messages between the computers, networks, and devices in FIG. 1 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

In step 51, a user using the user computing device 10 can first contact the authorizing entity computer 20. For example, the user, using the user computing device 10, may log on to a Website hosted by the authorizing entity computer 20, or may communicate with the authorizing entity computer 20 via an application on the user computing device 10.

After the user computing device 10 initially contacts the authorizing entity computer 20, the authorizing entity computer 20 can authenticate the user and/or the user computing device 10. The user may authenticate with the authorizing entity computer 20 in any suitable manner. For example, in some embodiments, the user of the user computing device 10 may provide a secret such as a password or PIN to the authorizing entity computer 20, and the authorizing entity computer 20 can verify the password or PIN. Alternatively or additionally, the authorizing entity computer 20 may provide a one-time passcode to the user's know address or device, and the user may be required to provide the one-time passcode back to the authorizing entity computer 20.

In step S2, after the user is authenticated, the authorizing entity computer 20 may send a request to obtain a list of token requestors from the token service computer 30. In some embodiments, the request may be made through an API.

In step S3, after the token service computer 30 receives the request for token requestors, the token service computer 30 can optionally retrieve the list of token requestors from a database, and then provide the list of token requestors to the authorizing entity computer 20. The list of token requestors can then be presented to the user computing device 10.

In step S4, the user may use the user computing device 10 to optionally select a token requestor from the list of token requestors. The authorizing entity computer 20 may then receive the selection of the token requestor from the user of the user computing device 10. In this example, the selected token requestor may be an entity that operates the processor computer 40. In some embodiments, the specific token requestor may be chosen for the user ahead of time, and the user need not specifically select the token requestor.

In step S5, after the processor computer 40 is selected as the token requestor, the authorizing entity computer 20 sends a payload of encrypted credentials (e.g., an encrypted payment instrument or an encrypted primary account number, expiration date, and CVV2), billing details (e.g., a bill number, an amount, a biller identifier, a date, etc.), and an optional user identifier, and an optional payment instrument identifier, to the processor computer 40. The billing details may include identifiers (e.g., an alphanumeric identifier) and/or addresses (e.g., IP addresses) for any billers used by the user.

The authorizing entity computer 20 may have previously obtained a list of billers (and their associated information such as biller identifiers, biller account numbers, etc.) from the user of the user computing device 10. Alternatively, the authorizing entity computer 20 may have previously gathered a list of billers associated with the user on its own. For instance, in some embodiments, the authorizing entity computer 20 could communicate with various billers to determine if they have used the user's payment credentials in the past.

In step S6, after receiving the encrypted payment credentials from the authorizing entity computer 20, the processor computer 40 decrypts the encrypted payment credentials, validates the payload, and then confirms receipt of the payload to the authorizing entity computer 20. In some embodiments, the processor computer 40 and the authorizing entity computer 20 may share a cryptographic key pair to allow them to encrypt and decrypt data.

In step S7, the processor computer 40 calls an enroll PAN API with the token service computer 30 to enroll the payment credentials (e.g., which may be in the form of a primary account number and additional relevant data such as a verification value and expiration date) received in the payload. After receiving the payment credentials, the token service computer 30 can store the enrolled payment credentials along with a token that can act as a substitute for the payment credentials.

In step S8, after receiving the payment credentials, the token service computer 30 then provisions a token or a token reference identifier associated with the token to the processor computer 40. The token may be an e-commerce/COF (card on file) token, which may only be validly used in an e-commerce, card on file type transaction. If the token is used in any other manner (e.g., in person at a store), then the use of the token would not be approved. At this point, the processor computer 40 may store the token or the token reference identifier along with other data including the biller details of the user's billers.

In some embodiments, a token cryptogram may also be created by the token service computer 30 and may be provided to the processor computer 40. In some embodiments, the token cryptogram may encrypt data including the token or real payment credential, and other static or dynamic data, as well as a channel indicator. The channel indicator may indicate the particular type of payment channel that the token may be used in. The token cryptogram can accompany the token or the token reference identifier during transaction processing. The cryptogram can be used to ensure that the token is being used in a predetermined manner, such as in a valid payment channel. Note that the token cryptogram may be created and provided to a token requestor when the when the token requestor is provisioned with a token, or when a payment transaction is conducted with the token.

In step S9, at a later point in time after the processor computer 40 has been provisioned with the token and/or token reference identifier, the biller computer 70 sends a bill to the authorizing entity computer 20. The bill may be a monthly bill from a utility, a streaming service, etc. The bill can be recurring or can be a one-time bill.

In step S10, the authorizing entity computer 20, via an issuer application, notifies the user via the user computing device 10 about the bill and payment options. The bill payment options could allow the user of the user computing device 10 to pay the bill, for example, by check, credit card, or debit card.

In step S11, using the user computing device 10, the user then selects an identifier for a particular payment instrument such as a credit or debit card as the payment method for the bill.

In step S12, the selected payment instrument and billing details (e.g., a bill identifier, billing date, and bill amount) about the bill to be paid are then communicated by the authorizing entity computer 20 to the processor computer 40.

In step S13, after the processor computer 40 receives the indication of the selected payment instrument and the billing details, processor computer 40 looks up the token or the token reference identifier corresponding to the payment credentials associated with the selected payment instrument. The processor computer 40 then sends the token or the token reference identifier associated with the token to the processing network computer 50. The processor computer 40 may also send the billing details of the bill to be paid to the processing network computer 50.

In step S14, if the processing network computer 50 received the token, then the processing network computer 50 transmits the token to the biller computer 70. If the processing network computer 50 received the token reference identifier, then the processing network computer 50 may communicate with the token service computer 30 to obtain the token from the token service computer 30. The token service computer 30 may receive the token reference identifier from the processing network computer 50, look up the token corresponding to the token reference identifier, and then provide the token to the processing network computer 70. In either case, the processing network computer 50 can then transmit the token to the biller computer 70. The billing details may be used to identify the biller computer 70.

In step S15, after the biller computer 70 receives the token from the processing network computer 50, the biller computer 70 generates and transmits an authorization request message with the token and the amount of the bill to be paid (an example of a particular interaction) to the transport computer 60.

In step S15A, the transport computer 60 can then transmit the authorization request message to the authorizing entity computer 20 for authorization. The authorizing entity computer 20 can then de-tokenize the token by providing the token to the token service computer 30. The token service computer 30 can then look up the real payment credential corresponding to the received token and can modify the authorization request message to include the real payment credential. After the authorizing entity computer 60 receives the authorization request message with the real payment credential and the transaction amount from the processing network computer 50, the authorizing entity computer 20 can then determine whether or not the transaction is authorized. The authorizing entity computer 20 can make this determination based upon at least whether or not there are sufficient funds and/or there the interaction appears to be not fraudulent.

In some embodiments, the processing network computer 50 can receive the authorization request message from the transport computer 60. The processing network computer 50 could de-tokenize the token in the authorization request message and obtain the real credential from the token service computer 30. The processing network computer 50 could then modify the authorization request message to include the real credential instead of the token, and can then determine the authorizing entity computer 20. The processing network computer 50 could then forward the authorization request message to the authorizing entity computer 20. The authorizing entity computer 20 could then determine whether or not the interaction is authorized (e.g., based upon whether or not there are sufficient funds and/or there the interaction appears to be not fraudulent).

In some embodiments, the previously described token cryptogram may have accompanied the token, and the processing network computer 50 and/or the token service computer 30 could validate the cryptogram to determine if the token is being used in the correct payment channel. For example, the authorization request message may also contain a channel indicator indicating that the transaction being conducted is for an e-commerce, card-on-file type transaction. The cryptogram can be decrypted using a cryptographic key corresponding to the cryptographic key that was used to create the cryptogram to obtain the channel indicator encoded in the cryptogram. This decrypted channel indicator can be compared with channel indicator received in the authorization request message to determine if the token is being used in the correct payment channel or not. If it is not, then an indicator of this may be included in the authorization request message, by the processing network computer 50 and/or the token service computer 30. The authorizing entity computer 20 can use this information to decide whether or not to authorize or decline the transaction. Alternatively, the processing network computer 50 could decline the transaction without further communicating with the authorizing entity computer 20.

In step S16A, the transport computer 60 may then receive an authorization response message comprising the token and an approval or decline indicator from the authorizing entity computer 20.

In some embodiments, the processing network computer 50 could receive the authorization response message comprising the token from the authorizing entity computer 20. The processing network computer 50 could then communicate with the token service computer 30 to re-tokenize the real credential (e.g., a PAN) by obtaining the token associated with the real credential. The processing network computer 50 can then insert the token into the authorization response message and then transmit it to the transport computer 60.

In step S16, the transport computer 60 then transmits the authorization response message to the biller computer 70.

In step S17, a payment confirmation is transmitted from the biller computer 70 to the authorizing entity computer 20.

In step S18, the authorizing entity computer 20 notifies the user computing device 10 that the payment of the bill was successful.

At the end of the day or at any other suitable period of time, the clearing and settlement process can be performed between the transport computer 60, the authorizing entity computer 20, and the processing network computer 50.

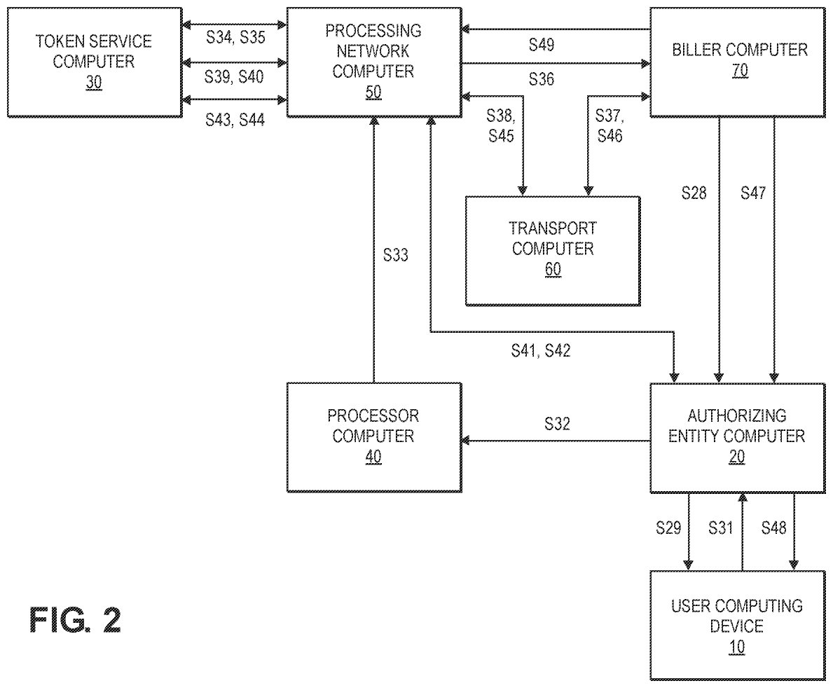

FIG. 2 shows a block diagram illustrating another system and method according to an embodiment of the invention. In the embodiment in FIG. 2, a processing network computer 50 can retrieve a token to continue with a transaction, instead of the processor computer 40 in FIG. 1.

Like the system in FIG. 1, the system in FIG. 2 includes a user computing device 10 that communicates with an authorizing entity computer 20 to pay a bill provided by a biller computer 70. The authorizing entity computer may communicate with a processor computer 40, which in turn communicates with a processing network computer 50. The processing network computer 50 communicates with a token service computer 30. The processing network computer 50 and the biller computer 70 communicate with a transport computer 60.

In step S28, the biller computer 70 may send a bill that is ready to be paid to the authorizing entity computer 20. The biller computer 70 may send the bill via an API with the authorizing entity computer 20 or through any other means.

Prior to receiving the bill, the biller computer 70 and/or the biller associated with the biller computer 70 may have been registered or enrolled with the authorizing entity computer 20 and/or the processing network computer 50, along with other billers used by the user of the user computing device 10.

In step S29, the authorizing entity computer 20 may present the bill to the user via the user computing device 10. For example, the user of the user computing device 10 may log on to a Website hosted by the authorizing entity computer 20, or may communicate with the authorizing entity computer 20 via an application on the user computing device 10.

In step S31, the user can decide to pay the bill electronically with a payment instrument such as a credit or debit card. The user then selects an identifier for the particular payment instrument to pay the bill.

In step S32, the user's decision to pay the bill, billing details, and the selected payment instrument (e.g., an identifier for the selected payment instrument) can then be sent to the processor computer 40.

In step S33, the processor computer 40 can transmit a message comprising biller information, transaction information, and the payment credentials associated with the selected payment instrument to the processing network computer 50. Such information may include a reference ID (or transaction ID), a processor computer ID, biller ID, a biller address, an amount, and data associated with the selected payment instrument, to the processing network computer 50. The data associated with the selected payment instrument may include a real credential or a token reference identifier (or some other payment instrument identifier). Other information that may be included in the message may include a user name, address of the user, etc. In some embodiments, the real credential or the token reference identifier may have been stored at the processor computer 40, or may have been received from the authorizing entity computer 20.

In steps S34 and S35, the processing network computer 50 can retrieve a token associated with the credential or the token reference identifier from the token service computer 30. In some embodiments, the processing network computer 50 can use the token reference identifier to retrieve the token from the token service computer 30 if it does not already have the token. The processing network computer 50 and/or the token service computer 30 can also generate a secure cryptogram that corresponds to the token. The secure cryptogram can be similar to the cryptogram described above in the process flow in FIG. 1, and the descriptions are incorporated herein, and need not be repeated. In some embodiments, the processing network computer 50 can also encrypt the token and the cryptogram. The processing network computer 50 can also retrieve the billing account number using a mapping table or service, if it did not receive this information from the processor computer 40.

In step S36, the processing network computer can initiate a payment using the encrypted payment data (e.g., at least the token and the cryptogram) and the amount. This data can then be sent to the biller computer 70 with the billing account number.

In some embodiments, an API can be used for secure communications between the processing network computer 50 and the biller computer 70. The message sent in step S36 can have an API Protocol/Format: REST/JSON.

Also, the Request Body may include the following data fields:

TABLE 1

| Field | Description |
|---|---|
| TransactionId | Unique identifier for the transaction, |
| | generated by the processing network |
| | computer |
| BillerId | Unique identifier of the Biller |
| | assigned by the processing network |
| | computer. Biller ID is assigned when |
| | biller is enrolled with the bill |
| | payment platform. |
| CustomerAccountInfo/ | User's account number with the |
| ServiceAccountNumber | Biller |
| CustomerAccountInfo/ | If provided, User will receive email |
| EmailAddress | confirmation sent directly by the |
| | Biller |
| CustomerAccountInfo/ | If required by the biller for account |
| CustomerName | verification. |
| CustomerAccountInfo/ | If required by the Biller for account |
| PhoneNumber | verification |
| CustomerAccountInfo/ | If required by the Biller for account |
| ServicePostalCode | verification. |
| PaymentInfo/Amount | Payment amount |
| PaymentInfo/Token | Token (16-digits which can be used |
| | in place of PAN) |
| PaymentInfo/Cryptogram | Cryptogram (3-digit DTVV which |
| | can be used in place of CVV2) |
| PaymentInfo/CardExpiration | Expiry date of the card. |
| | Format: YYYY-MM |
| PaymentInfo/CardPostalCode | Postal code of the card |

A Sample Request Body is as follows:

```
{
  “TransactionId”: “123456”
  “BillerID”: “123”,
  “CustomerAccountInfo”: {
    “ServiceAccountNumber”: “1234567890”
    “EmailAddress”: “lbestrow@visa.com”,
    “PhoneNumber”: “+1 -6504323200”,
    “ServicePostalCode”: “94105”
  },
  “Paymentinfo”: {
    “Amount”: “50.00”,
    “Token”: “1234567890123456”,
    “Cryptogram”: “123”,
    “CardExpiration”: “2020-12”,
    “CardPostalCode” “94404”,
    “CardholderName”: “Lacey Bartlett”
  }
}
```

In step S37, the biller computer 70 can initiate a payment transaction using the token, the cryptogram such as a dynamic token verification value (DTVV), and the amount. For example, the biller computer 70 may generate an authorization request message comprising the token, the cryptogram, and the amount, and may transmit the same to the transport computer 60, which may be operated by an acquirer associated with the biller operating the biller computer 70.

In step S38, the transport computer can route the authorization request message to the processing network computer 50.

In steps S39 and S40, the processing network computer 50 can obtain the real credential associated with the token in the authorization request message, by contacting the token service computer 30. The processing network computer 50 and/or the token service computer 30 may also validate the cryptogram in a manner similar to the method described above in FIG. 1. The processing network computer 50 can then modify the authorization request message to include the real credential.

In step S41, the processing network computer 50 can transmit the modified authorization request message comprising the real credential and the transaction amount to the authorizing entity computer 20. The authorizing entity computer 20 can then determine if the transaction is or is not authorized.

In step S42, the authorizing entity computer 20 can send an authorization response message comprising the real credential to the processing network computer 50.

In steps S43, S44 the processing network computer 50 can retrieve the token that corresponds with the real credential, and can modify the authorization response message to include the token.

In step S45, the processing network computer 50 can send the authorization response message comprising the token to the transport computer 60.

In step S46, the transport computer 60 can send the authorization response message to the biller computer 70.

In step S47, the biller computer 70 can provide confirmation of the transaction to the authorizing entity computer 20. In step S48, the authorizing entity computer 20 can provide the confirmation of the transaction to the user computing device 10.

In step S49, the biller computer 70 may also provide confirmation of the account posting to the processing network computer 50. The previously described API may be used to allow for communication between the biller computer 70 and the processing network computer 50. The confirmation may include a Response Body, which may include the following:

| Field | Description |
|---|---|
| Status | Status of the bill payment transaction |
| | (e.g., Accepted/Rejected) |
| ConfirmationNumber | Payment confirmation number from the |
| | Biller |
| TotalAmountCharged | Total amount charged to the user's card |
| | (total = original amount + service fee) |
| ServiceFee | Service fee amount (if applicable) |
| PostedDateTime | Date/time the payment posted |

A Sample Response Body may be as follows:

```
{
  “Status”: “ACCEPTED”,
  “ConfirmationNumber”: “12345”,
  “TotalAmountCharged”: “52.25”,
  “ServiceFee”: “2.25”,
  “PostedDateTime”: “2020-08-04T19:28:38.000Z”
}
```

At the end of the day or at any other suitable period of time, the clearing and settlement process can be performed between the transport computer 60, the authorizing entity computer 20, and the processing network computer 50.

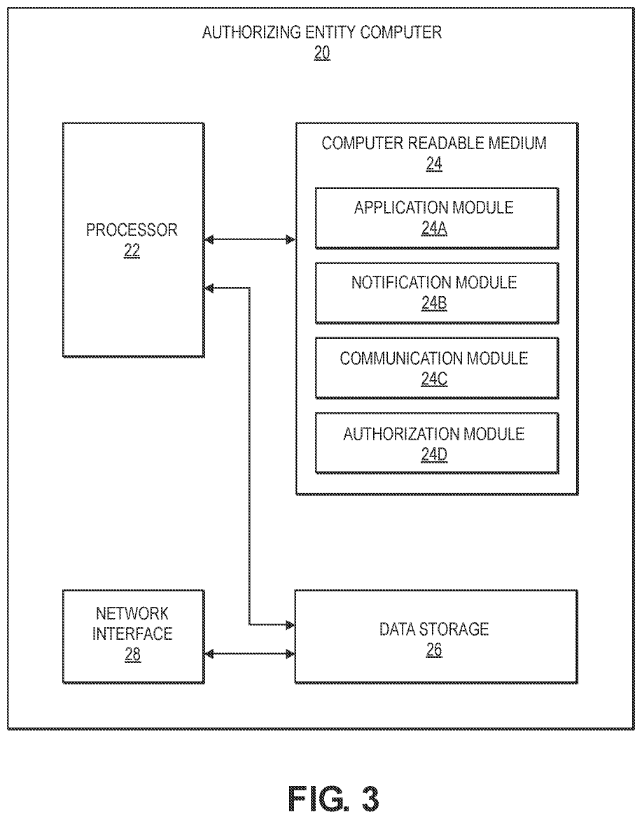

FIG. 3 shows a block diagram of an authorizing entity computer 20 according to an embodiment. The authorizing entity computer 20 may comprise a processor 22, which may be coupled to a computer readable medium 24, data storage 26, and a network interface 28.

The data storage 26 may contain access data such as tokens and/or account data, as well as mappings between access data, credentials, and/or communication device identifiers such as phone numbers, IP addresses, device identifiers, etc. The data storage 26 may also store mappings between various billers that are used by users, and user data (e.g., payment credentials, tokens, or token reference identifiers associated with users, home addresses of users, user identifiers, etc.) associated with those users.

The computer readable medium 24 may comprise a number of software modules including an application module 24A, a notification module 24B, a communication module 24C, and an authorization module 24D. The computer readable medium may also compose code for APIs.

The network interface 28 may be any suitable combination of hardware and software that enables data to be transferred to and from authorizing entity computer 20. Some examples of network interface 28 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by communication interface 106C may include Wi-Fi.

Data transferred via the network interface 28 may be in the form of signals which may be electrical, electromagnetic, optical, or any other signal capable of being received by the external communications interface (collectively referred to as “electronic signals” or “electronic messages”). These electronic messages that may comprise data or instructions may be provided between communication interface 106C and other devices via a communications path or channel. Any suitable communication path or channel may be used such as, for instance, a wire or cable, fiber optics, a telephone line, a cellular link, a radio frequency (RF) link, a WAN or LAN network, the Internet, or any other suitable medium.

The application module 24A may include code that causes the processor 22 to interact with an authorizing entity application on a user computing device. The application module 24A, in conjunction with the processor 22, can provide certain functionality to an application on the user computing device.

The notification module 24B may include code that causes the processor 22 to generate notification messages. The notification messages may be sent to any suitable devices including a user computing device, a processing network computer, a biller computer, etc. The notifications can take any suitable form including e-mails, text messages, and the like.

The communication module 24C may comprise code that causes the processor 22 to generate messages, forward messages, reformat messages, and/or otherwise communicate with other entities.

The authorization processing module 24D may comprise code that can cause the processor 22 to evaluate authorization request messages for transactions and determine if the transactions should be authorized. The authorization processing module 604A may also include code for routing or modifying authorization request and response.

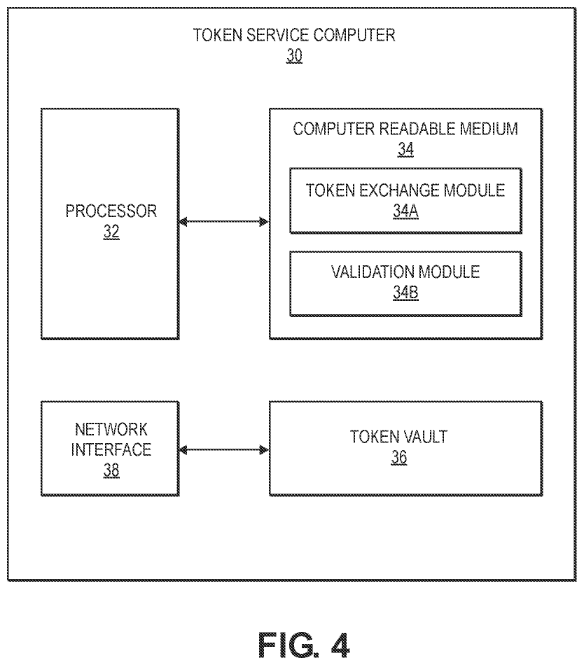

FIG. 4 shows a token service computer 30 according to an embodiment. The token service computer 30 includes a processor 32 and a computer readable medium 34, a token vault 36, and a network interface 38 coupled to the processor 32.

The computer readable medium 34 may comprise a token exchange module 34A and a validation module 34B.

The token vault 36 may store tokens and their associated credentials in a database. The token vault 36 may store data in a database such as an Oracle™ database.

The tokenization exchange module 34A may comprise code that causes the processor 32 to provide access tokens. For example, the token exchange module 34A may contain logic that causes the processor 32 to generate a payment token and/or associate the payment token with a set of payment credentials. A token record may then be stored in a token record database indicating that the payment token is associated with a certain user or a certain set of payment credentials.

The validation module 34B may comprise code that causes the processor 32 to validate token requests before a payment token is provided. For example, validation module 34B may contain logic that causes the processor 32 to confirm that a token request message is authentic by decrypting a cryptogram included in the message, by confirming that the payment credentials are authentic and associated with the requesting device, by assessing risk associated with the requesting device. The validation module 34B, in conjunction with the processor 32, may also perform the cryptogram validation processes described above with respect to FIG. 1.

The computer readable medium 34 may also comprise code, executable by the processor including instructions which cause the authorizing entity computer to receive, from a user computing device; a request to pay a bill from a biller computer using a credential; transmit an initiation message to a processor computer which stores a token or a token reference identifier associated with the token, wherein the processor computer transmits the token or the token reference identifier to a processing network computer, which uses the token to process the bill; and receive, from the biller computer, a confirmation that the bill has been processed.

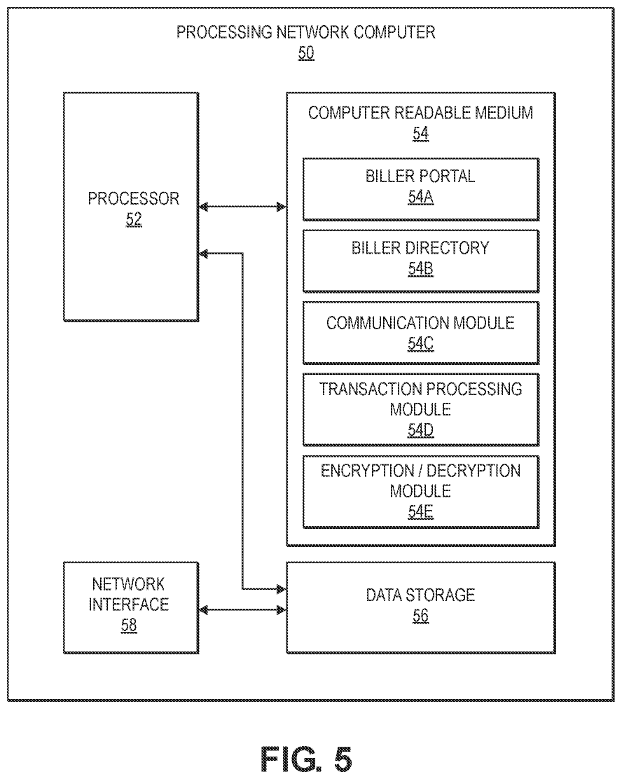

FIG. 5 shows a block diagram of a processing network computer 50 according to an embodiment. The processing network computer 50 may comprise a processor 52, which may be coupled to a computer readable medium 54, data storage 56, and a network interface 58.

The data storage 56 may contain access data such as tokens and/or account data, as well as mappings between billing data, credentials, tokens, and/or communication device identifiers such as phone numbers, IP addresses, device identifiers, etc.

The computer readable medium 54 may comprise a number of software modules including a biller portal 54A, a biller directory 54B, a communication module 54C, and a transaction processing module 54D. The computer readable medium may also comprise a clearing and settlement module (not shown).

The biller portal 54A may comprise code, executable by the processor 52, which can allow the processing network computer 50 to interact with a number of different biller computers. The biller portable 54A may include a number of APIs that connect to each biller.

The biller directory 54B may comprise a directory of billers and their associated biller computers. The biller directory may comprise information about each specific biller including specific billing formats, biller computer identifiers and addresses, mappings between biller computers and authorizing entity computers, etc.

The communication module 54C may comprise code that causes the processor 52 to generate messages, forward messages, reformat messages, and/or otherwise communicate with other entities.

The transaction processing module 54D may comprise code that can cause the processor 52 to evaluate authorization request messages for transactions and determine if the transactions should be authorized. The authorization processing module 54A may also include code for routing or modifying authorization request and response messages as they pass between various parties such as authorizing entity computers (e.g., issuer computers) and transport computers (e.g., acquirer computers). The transaction processing module 54D may also, in conjunction with the processor 52, perform clearing and settlement functions between various computers such as transport computers and authorizing entity computers. The transaction processing module 54D, in conjunction with the processor 52, may also retrieve tokens or credentials from a token service computer.

The encryption/decryption module 54E may include any suitable encryption/decryption algorithms to encrypt data in embodiments of the invention. Suitable data encryption/decryption algorithms may include DES, triple DES, AES, etc. It may also store encryption keys that can be used with such encryption/decryption algorithms. The encryption module 54E may utilize symmetric or asymmetric encryption techniques to encrypt and/or verify data. Cryptographic keys that may be used by the encryption/decryption module 54E may be securely stored in the data storage 56.

The computer readable medium 54 may comprise instructions, executable by a processor, to cause the processing network computer to: receive a token associated or a token reference identifier associated with the token from a processor computer, transmit the token to a biller computer, which uses the token to process the bill, by generating an authorization request message comprising the token for an interaction involving the bill; receive the authorization request message comprising the token; retrieve a credential associated with the token; and transmit a modified authorization request message including the credential to an authorizing entity computer, which authorizes the interaction.

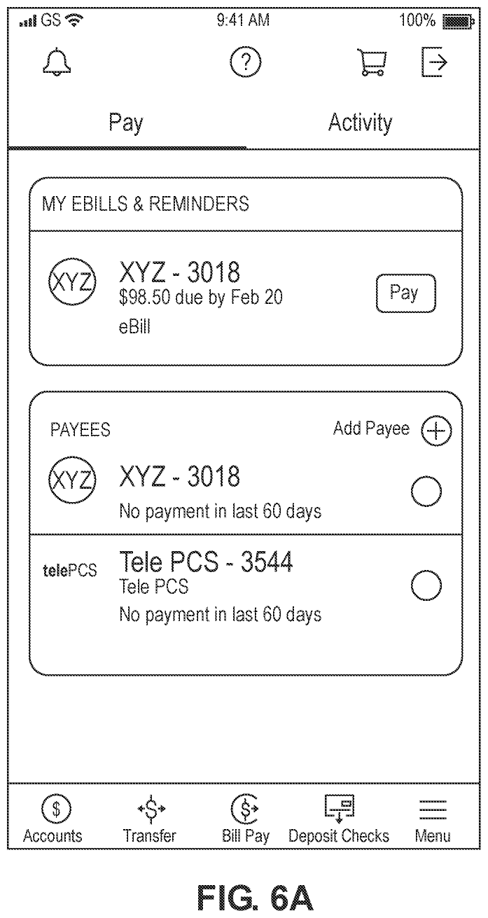

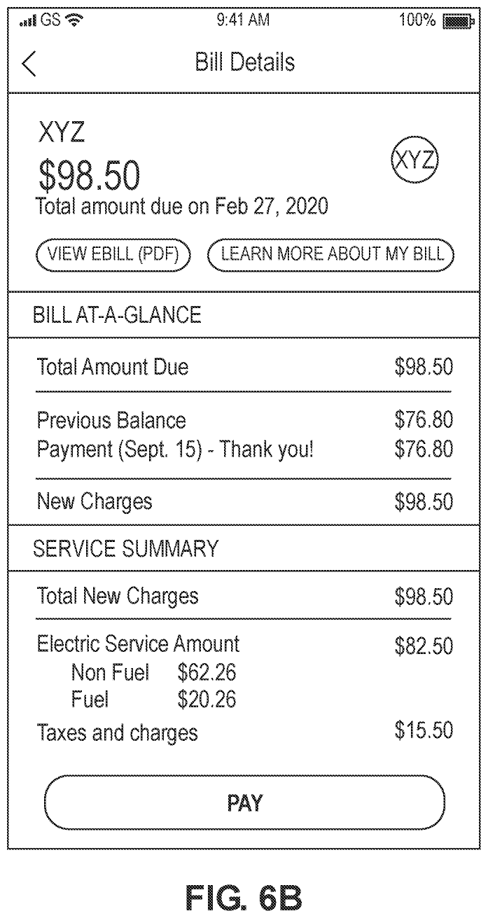

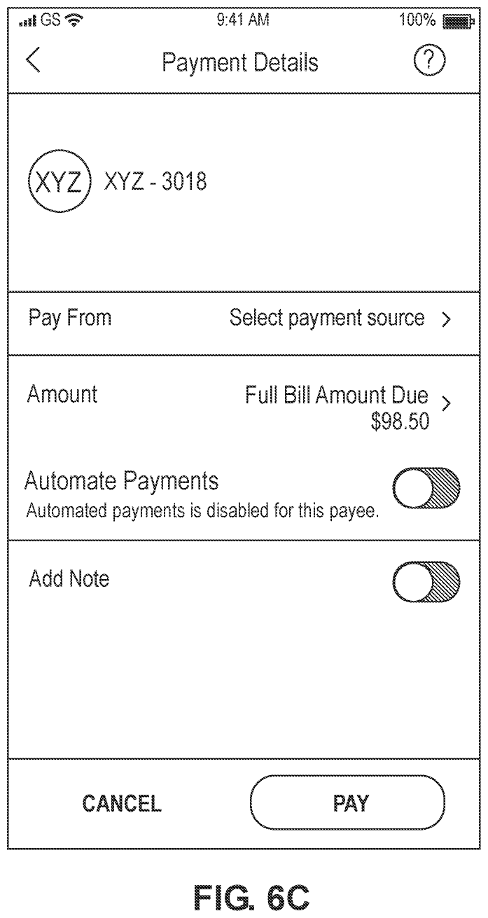

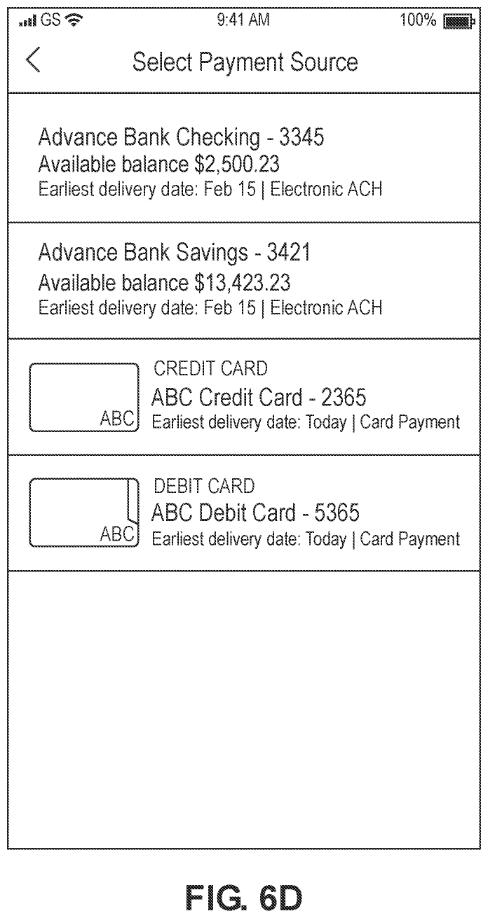

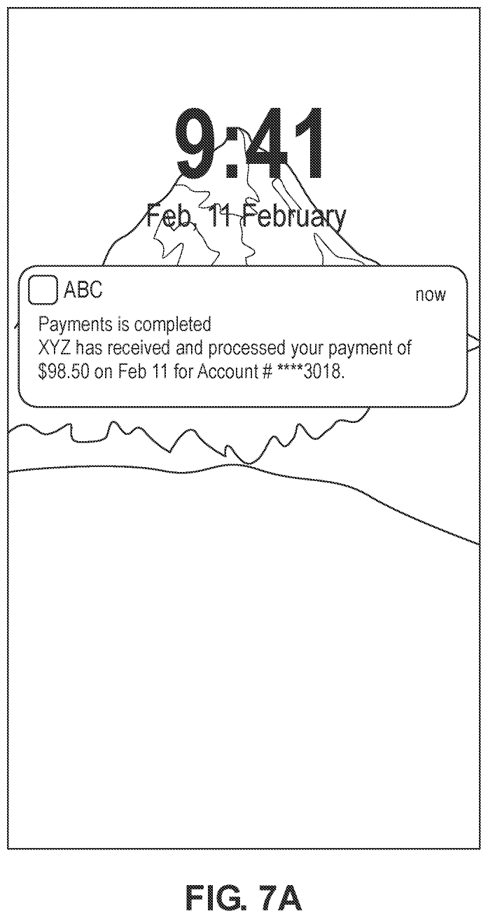

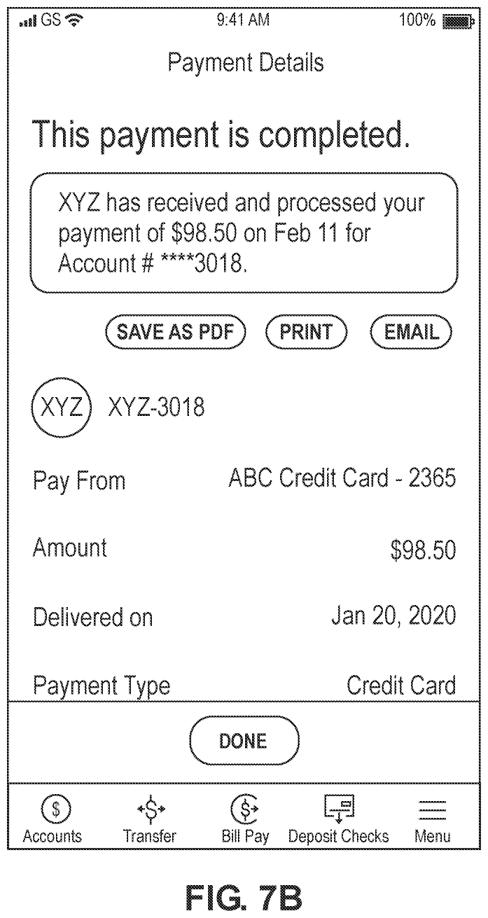

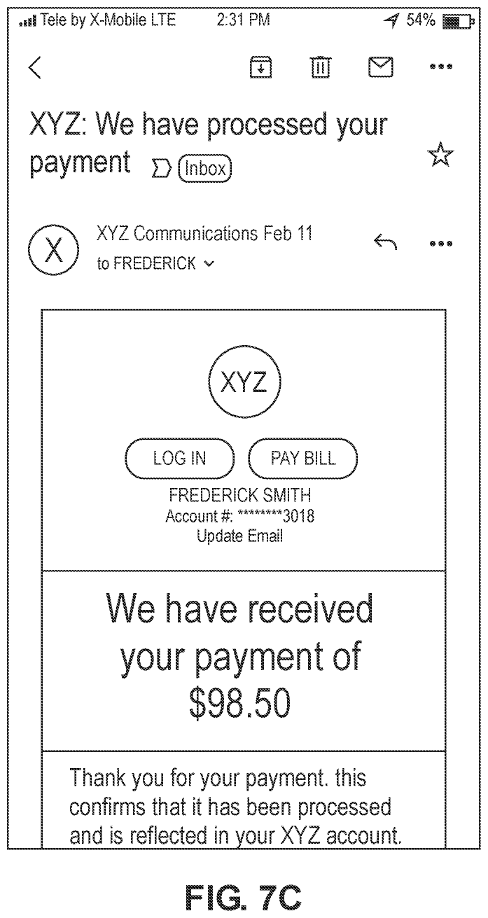

FIGS. 6A-6D and 7A-7C show user interfaces for bill presentment according to another embodiment. The interfaces may be provided on an application on a user computing device.

FIG. 6A shows a screenshot of a new bill, together with an amount and a due date on an application on a user computing device. The application is provided by an authorizing entity computer. As shown in FIG. 6A, a number of the user's billers may be presented to the user on the user computing device. Selectable buttons are provided to allow the user to select particular bills to pay. As shown, the user does not need to log in to many different biller computers to pay the user's bills, thus reducing the number of communications that would otherwise be needed.

FIG. 6B shows a screenshot of additional details about the bill and an option for paying the bill electronically.

FIG. 6C shows a screenshot of payment details, with an option for selecting a payment method, and also a mode of payment (e.g., pay in full or pay monthly).

FIG. 6D shows a screenshot of payment methods that can be selected by the user. As shown, the user has the option to pay for the bill using various payment instruments or accounts, including a debit card, a credit card, a savings account, or checking account.

FIG. 7A shows a screenshot of a notification that electronic payment for a bill has been completed.

FIG. 7B shows a screenshot of additional details for a completed payment. Such details include an indication of the amount paid, the payment date, the biller, as well as the payment instrument used to conduct the payment.

FIG. 7C shows a screenshot of an email with a payment confirmation.

The confirmation may include a button to allow the user to communicate with the biller directly.

Embodiments of the invention have a number of advantages. For example, because payment tokens are used to process payments instead of real credentials, any real credentials are secure and cannot be obtained by unauthorized persons such as a man-in-the-middle. Further, as illustrated by the above embodiments, separate payment registration interactions need not be performed by the users. Rather, a user can interact with one authorizing entity computer to initiate payment of one or multiple payments to the user's billers.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a processing network computer, a token or a token reference identifier associated with the token from a processor computer,
transmitting, by the processing network computer, the token to a biller computer, which uses the token to process the bill, by generating an authorization request message comprising the token for an interaction involving the bill;
receiving, by the processing network computer, the authorization request message comprising the token;
retrieving a credential associated with the token; and
transmitting a modified authorization request message including the credential to an authorizing entity computer, which authorizes the interaction.

2. The method of claim 1, wherein the processing network computer receives the token reference identifier from the processor computer, and the method further comprises:
retrieving the token and a token cryptogram from a token service computer using the token reference identifier.

3. The method of claim 2, further comprising, transmitting the token cryptogram with the token to the biller computer.

4. The method of claim 3, wherein the cryptogram encrypts data including the credential and a channel indicator, the cryptogram identifying a valid interaction channel for the interaction.

5. The method of claim 1, wherein the processing network computer receives the authorization request message comprising the token from the biller computer via a transport computer.

6. The method of claim 1, further comprising:
receiving an authorization response message from the authorizing entity computer.

7. The method of claim 6, further comprising:
modifying the authorization response message to include the token; and
transmitting the modified authorization response message to the biller computer.

8. The method of claim 1, wherein the processing network computer transmits the token to the biller computer via an API.

9. The method of claim 8, wherein the API includes data fields including a token data field for the token, a cryptogram data field, and a postal code data field.

10. The method of claim 9, wherein the API further includes data fields including a transaction identifier and a biller identifier.

11. A processing network computer comprising:
a processor; and
a non-transitory computer readable medium, the non-transitory computer readable medium comprising instructions, executable by a processor, to cause the processing network computer to:
receive a token or a token reference identifier associated with the token from a processor computer,
transmit the token to a biller computer, which uses the token to process the bill, by generating an authorization request message comprising the token for an interaction involving the bill;
receive the authorization request message comprising the token;
retrieve a credential associated with the token; and
transmit a modified authorization request message including the credential to an authorizing entity computer, which authorizes the interaction.

12. The processing network computer of claim 11, wherein the non-transitory computer readable medium further comprises a biller directory which includes addresses of billers and biller identifiers.

13. The processing network computer of claim 11, wherein the token is a substitute for the credential.

14. The processing network computer of claim 11, wherein the token has a same format as the credential.

15. A method comprising:
receiving, by an authorizing entity computer and from a user computing device; a request to pay a bill from a biller computer using a credential;
transmitting, by the authorizing entity computer, an initiation message to a processor computer which stores a token associated with the credential or a token reference identifier associated with the token, wherein the processor computer transmits the token or the token reference identifier to a processing network computer, which uses the token to process the bill; and
receiving, by the authorizing entity computer from the biller computer, a confirmation that the bill has been processed.

16. The method of claim 15, further comprising, receiving the bill from the biller computer, prior to receiving the request to pay the bill; and
presenting the bill to an application on the user computing device.

17. The method of claim 15, wherein the processor computer stores the token reference identifier associated with the token, wherein the processor computer transmits the token reference identifier to the processing network computer, which uses the token reference identifier to retrieve the token and then uses the token to process the bill.

18. The method of claim 15, wherein the processor computer stores the token, and wherein the processor computer transmits the token to the processing network computer, which uses the token to process the bill.

19. The method of claim 15, further comprising:
providing to an interface to the user computing device that allows a user of the user computing device to select the credential from a list of different types of credentials.

20. The method of claim 15, further comprising:
providing to an interface to the user computing device that allows a user of the user computing device to select a biller from a list of different billers.
